(19) United States
(12) Patent Application Publication
(10) Pub. No.: US 2011/0304823 A1
(43) Pub. Date: Dec. 15, 2011

(54) AWNING

(75) Inventors: Marius WENSING, Rosendahl (DE); Daniel HÔLKER, Altenberge (DE); Gûnther SCHÖTTLER, Emsdetten (DE)

(73) Assignee: SCHMITZ-WERKE GMBH + CO. KG, Emsdetten (DE)

(21) Appl. No.: 13/155,694

(22) Filed: Jun. 8, 2011

(30) Foreign Application Priority Data
Jun. 9, 2010 (DE) 10 2010 029 879.4

(51) Int. Cl. G03B 31/00; G03B 21/58; H04R 5/02; E04F 10/02

(52) U.S. Cl. 353/15; 160/22; 359/444; 381/307

(57) ABSTRACT

An awning includes
a base part, which can be attached to a building part,
a fabric shaft rotatably mounted thereon,
an awning fabric, which can be retracted and extended and can be wound onto the fabric shaft and unwound therefrom, and
a sound production system, which has a driver controller and at least one sound actuator activated thereby and coupled to an awning component, wherein the at least one sound actuator causes the awning component to carry out defined oscillations to emit a sound signal, in particular a music and/or speech signal.

### CROSS-REFERENCES TO RELATED APPLICATIONS

This application claims the priority of German Patent Application, Serial No. 10 2010 029 879.4, filed Jun. 9, 2010, pursuant to 35 U.S.C. 119(a)-(d), the content of which is incorporated herein by reference in its entirety as if fully set forth herein.

### FIELD OF THE INVENTION

The invention relates to an awning with a base part, which can be attached to a building part, a fabric shaft which can be rotatably driven thereon, preferably by means of a motor, and an awning fabric, which can be retracted and extended and can be wound onto the fabric shaft and unwound therefrom. The base part is to be taken to mean here any component, with the aid of which the awning, for example a joint arm awning, winter garden awning or window awning, can be fastened to a building part, such as an external wall, a winter garden or a window reveal. Typically, base parts of this type, owing to the type of construction, are awning housings, fastening brackets, holding frames or the like.

### BACKGROUND OF THE INVENTION

It is to be noted regarding the background to the invention that awnings are preferably used in the areas of recuperation and relaxation, such as terraces and balconies. In this context, it is increasingly desired for there to, as far as possible, be multi-media provision. For this purpose, it is already known to equip awnings, for example in the region of their drop out profiles, with loudspeakers to provide the space located below the awning with sound. Alternative configurations provide for attaching loudspeaker boxes, for example, to the awning housing, by means of brackets.

The drawback in the known solutions is the fact that relatively expensive loudspeaker systems have to be used to produce satisfactory sound quality and an adequate sound volume for providing sound in the open air, which generally clashes with the possibility of integration into awning components or attachment to the awning.

### SUMMARY OF THE INVENTION

Proceeding from the problems outlined of the prior art, the invention is based on an object of improving an awning in such a way that it as optimally as possible fulfils multi-media objects.

This object is achieved according to the invention by a sound production system, which has a driver controller and at least one sound actuator activated thereby and coupled to an awning component. This at least one sound actuator causes the awning component to carry out defined oscillations to emit a sound signal, in particular a music and/or speech signal.

In contrast to the loudspeakers known from the prior art, a component of the awning, such as, for example, a surface of the drop out profile, the awning fabric itself or a wall of the awning housing is directly used, therefore, as the sound-producing element, which component is caused to carry out corresponding oscillations by means of the sound actuator. When implementing this technical approach, the extensive experience with adaptive audio systems can be utilised, such as is available, for example, from the company Bose® in conjunction with their “Acoustic Waveguide Technology” or the “ADAPTiQ®”—audio calibration system.

Depending on the demands regarding the sound quality and the sound volume, a plurality of sound actuators may be provided for acting on one or more awning components.

The driver controller provided according to the invention is moreover to be taken to mean the core of the sound production system provided to activate the sound actuator(s), which core, in accordance with conventional audio systems, has at least one signal production component for producing analogue or digital sound control signals, with which a power amplifier is activated. This then supplies the sound actuators with the actual music or speech control signals to cause the respective awning component to carry out its defined oscillations. The supply of the driver controller with the corresponding sound control signals can take place by all known methods, such as line-bound ones, by WLAN, short-range radio standards, such as Bluetooth or else by docking on a memory module via an intersurface, such as, for example, a USB port. The currently conventional MP3 players, iPods® or iPhones®, for example, can be connected via the latter.

Qualitatively high-grade sound patterns, such as stereo or Dolby® surround sound can be produced by the preferably provided use of a plurality of sound actuators in defined coupling to a plurality of awning components.

For comprehensive multi-media use of an awning, the latter may be provided, in accordance with a preferred embodiment, with an image projection surface, which may preferably be a screen element hanging down from the drop profile. An additional drop curtain offered by the Applicant as special equipment under the name “Schatten Plus” can basically be used for this, and can be retracted and extended by means of an additional winding shaft in the drop out profile. This additional drop curtain only has to be provided, as a screen element, at least on the inside, with a homogeneously light-reflective coating or material layer.

The integration of a corresponding projection device into the awning is recommended as a particularly preferred embodiment of an awning in conjunction with the projection surface as an additional device. According to the current prior art, this is primarily a beamer, with the aid of which still and moving images can be produced on the projection surface. With a corresponding complete equipping of an awning with a sound production system, projection device and projection surface, this awning realises a self-sufficient multi-media system, which can be optimally used precisely during times of recuperation and relaxation on a terrace or a balcony.

Further features, details and advantages of the invention emerge from the following description of an embodiment with the aid of the accompanying drawings

### BRIEF DESCRIPTION OF THE DRAWINGS

FIG. 1 shows a rear view of an awning in a partially opened state, and

FIGS. 2 and 3 show enlarged detailed views of the details E and F according to FIG. 1.

### DESCRIPTION OF THE PREFERRED EMBODIMENT

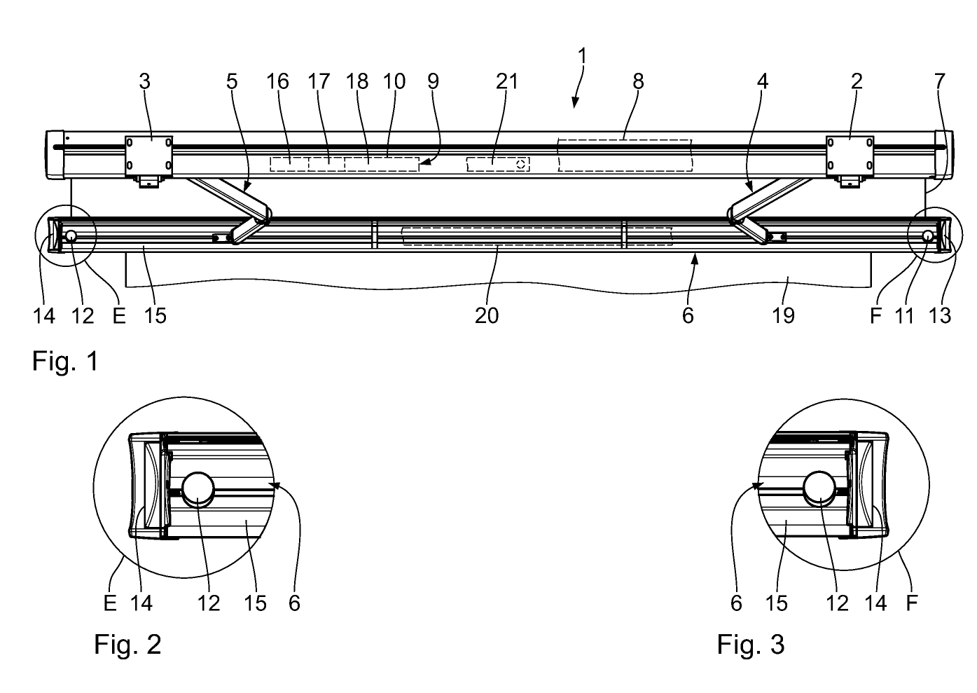

As becomes clear from FIG. 1, the articulated arm awning shown has, as a base part, the awning housing 1, which can be mounted by corresponding brackets 2, 3 on a building part, not shown in more detail, such as an external building wall.

Further base parts of the awning provide two articulated arm pairs 4, 5, which are articulated by their inner ends to the awning housing 1. Their free ends carry the drop out profile 6 as a further base part of the awning, on which the front end of the awning fabric 7 is fastened. The latter is generally wound, when the awning is retracted, onto the fabric shaft 8, shown by dashed lines, in the awning housing 1.

The awning shown is designed as a multi-media awning. For this purpose, a sound production system designated as a whole by 9 is provided, which consists of a driver controller 10, which is accommodated in the awning housing 1, and two sound actuators 11, 12. In the embodiment shown, the latter are mechanically coupled to the two outer ends 13, 14 of the drop out profile 6. These may be piezo-electric oscillation generators, which cause the corresponding front wall 15 of the drop out profile 6 to carry out defined oscillations to emit a sound signal, such as a music and speech signal. The correspondingly produced sounds and tones can then be perceived, in particular below the awning in the rest region shaded thereby.

The driver control 10, for example, has a WLAN receiving part 16, with which analogue or, in particular, digital sound control signals can be wirelessly received. These sound control signals may, for example, be transmitted by a PC system inside the house. These signals are processed in a processor part 17, in order to activate an end stage 18 in such a way that the latter emits defined power signals to the sound actuators 11, 12 via line connections, not shown in more detail.

To provide an image projection surface, the awning is also provided with a screen element 19, which can be wound onto an additional winding shaft 20 in the drop out profile 6 and unwound therefrom. The screen element can be extended downward in such a way that it hangs vertically down from the drop out profile 6.

A beamer 21, which can be supplied, for example, via the WLAN receiving part 16 of the sound production system 9 with corresponding image signals, is finally integrated, as a projection device, into the awning housing 1. The beamer 21 then projects the corresponding images or films onto the screen element 19.

1-11. (canceled)

12. An awning comprising
a base part, which can be attached to a building part,
a fabric shaft rotatably mounted thereon, and
an awning fabric, which can be retracted and extended and can be wound onto the fabric shaft and unwound therefrom,
comprising
a sound production system, which has a driver controller and at least one sound actuator activated thereby and coupled to an awning component, wherein the at least one sound actuator causes the awning component to carry out defined oscillations to emit a sound signal.

13. An awning according to claim 12, wherein a plurality of sound actuators is provided to act on at least one awning components.

14. An awning according to claim 12, wherein at least one of the base part in the form of an awning housing, the awning fabric and a drop out profile of the awning are coupled to a sound actuator.

15. An awning according to claim 12, wherein the driver controller can be supplied by at least one of line-bound and wireless communication paths with at least one of analogue and digital sound control signals.

16. An awning according to claim 12, wherein the driver controller can be supplied by at least one of line-bound and wireless communication paths with at least one of music and speech control signals

17. An awning according to claim 12, wherein a plurality of sound actuators is coupled to a plurality of awning components in such a way that they together emit one of the group of stereo and surround sound signals.

18. An awning according to claim 12, wherein the awning is provided with an image projection surface.

19. An awning according to claim 17, wherein the image projection surface is formed by a screen element hanging down from the drop out profile of the awning.

20. An awning according to claim 18, wherein the screen element can be retracted and extended by means of a winding shaft in the drop out profile.

21. An awning in particular according to claim 17, wherein a projection device is integrated into the awning.

22. An awning at least according to claim 20, wherein the projection device is a beamer integrated into the awning housing.

23. An awning according to claim 12, wherein the at least one sound actuator causes the awning component to carry out defined oscillations to emit at least one of a music and speech signal.
